(19) United States
(12) Patent Application Publication
(10) Pub. No.: US 2026/0027762 A1
(43) Pub. Date: Jan. 29, 2026

(54) METHOD AND BLOWN FILM LINE FOR CONTROLLING A BLOWN FILM LINE

(71) Applicant: Kdesign GmbH, Königswinter (DE)

(72) Inventors: Richard ZIMMERMANN, Königswinter (DE); Daniel LAMERS, Königswinter (DE)

(73) Assignee: Kdesign GmbH, Königswinter (DE)

(21) Appl. No.: 19/345,429

(22) Filed: Sep. 30, 2025

Related U.S. Application Data
(63) Continuation of application No. PCT/EP2024/058925, filed on Apr. 2, 2024.

(30) Foreign Application Priority Data
Apr. 3, 2023 (EP) 22166338.6

(51) Int. Cl. B29C 48/885; B29C 48/00; B29C 48/10; B29C 48/88; B29C 48/90

(52) U.S. Cl. CPC B29C 48/885; B29C 48/0018; B29C 48/10; B29C 48/903; B29C 48/907; B29C 48/912

(57) ABSTRACT

A method for post-tempering a film tube extruded by a blown film line includes: ejecting the film tube in a haul-off direction along a longitudinal axis of the blown film line by a blow head; blowing cooling gas onto the film tube relative to the haul-off direction downstream of the blow head to solidify the film tube at a frost line; post-tempering the film tube by a post-tempering unit having a plurality of adjustable blowing elements downstream of the frost line for blowing tempering gas onto the film tube; adapting a diameter of a feed-through opening formed by the blowing elements to a diameter of the film tube by adjusting the blowing elements; measuring the actual temperature of the film tube downstream of at least one of the blowing elements; and regulating the temperature of the film tube to a target temperature by blowing tempering gas onto the film tube.

### CROSS-REFERENCE TO RELATED APPLICATIONS

This application is a continuation of International Application No. PCT/EP2024/058925, filed on Apr. 2, 2024, which claims priority to and the benefit of EP 22166338.6, filed on Apr. 3, 2023. The disclosures of the above applications are incorporated herein by reference.

### FIELD

The present disclosure relates to a method and a blown film line for producing a film tube from plasticized thermoplastic material.

### BACKGROUND

The statements in this section merely provide background information related to the present disclosure and may not constitute prior art.

EP 1 491 319 A1 shows a blown film line which comprises gas suction means surrounding the film tube downstream of the calibrating basket with essentially annularly arranged suction nozzles for extracting monomer-containing evaporations. Immediately above, i.e. downstream of the gas suction means, a post-tempering unit is arranged outside the film tube in the form of a further cooling gas ring, which is designed as a rigid ring with a fixed, unchangeable internal diameter for the film tube to pass through.

Above or downstream of the additional cooling ring, the film tube runs into a collapsing unit that compresses the film tube flat. The film tube is pulled off downstream of the collapsing unit by means of a haul-off unit. The flattened film tube is then wound onto coils.

The film tube, which is still relatively warm, can be cooled with the additional cooling gas ring before it enters the collapsing unit, so that there is less risk of the film layers blocking (sticking to each other) in the haul-off unit after the film tube has been fold-ed. This means that the film layers cannot be separated from each other, or only with difficulty, when winding onto several coils or during subsequent processing.

During the extrusion of film tubes, certain recipes and products result in so-called flatness errors in the film produced. Such flatness errors are, for example, waves with any distribution, sagging in the area of the edges and so-called camber.

Such errors are clearly visible when the film is unrolled from the finished coil and rolled out on the floor without tension. Put simply, flatness errors are local length deviations of individual film areas across the web width.

These faults can often be detected visually in the film web under tension on the way from the haul-off to the winder or within the winder.

Measuring devices are known which measure the flatness of the web in the transverse direction between guide rollers on the way from the haul-off to the winder or in the winder. Furthermore, measuring devices are known which record the geometric quality of the coil as it builds up. This is intended to ensure that poor flatness quality is detected at an early stage.

Control loops are also proposed in which such measuring devices are coupled with stretching units, which are intended to improve the flatness by heating and stretching the film tube after the haul-off.

In the area of the still round film tube, heating tunnel devices are known which heat the film tube again above the frost line using infrared radiant heaters arranged in a fixed diameter in order to improve the flatness quality of the film which is later collapsed. This utilizes the effect that uneven stress distributions due to different molecular orientations on the circumference of the film tube and the resulting local length differences are reduced again by reheating, so that flatness errors in the collapsed film are significantly reduced or completely prevented.

The uneven stress distributions are mainly caused by flow effects in the extrusion die of the blow head, for example by a flow channel design that does not optimally match the raw material, by an unsuitable heating profile of the extrusion die, or by an uneven circumferential temperature distribution and/or circumferential volume distribution of the melt inside and at the outlet from the extrusion die.

In addition, a calibration basket that is set at a height that does not match the frost line of the film tube, excessive contact pressure (filling level) in the calibration basket or a calibration basket that is slightly off-center in relation to the extrusion die can also cause flatness errors.

Flatness errors that occur during the flattening process itself are of minor importance if the film tube enters the flattening process as unencumbered as possible by any flatness errors that have already occurred.

Cross-profile control systems known in the state of the art, which intervene to correct the cooling of the bubble in the tube formation zone between the extrusion die and the frost line, can significantly lessen the problems mentioned, but cannot completely prevent them in the case of many flatness-sensitive products.

A disadvantage of the heating tunnel devices is the rigid arrangement of the radiant heaters, because a wide range of different bubble diameters is usually produced. The variable distance between the film and the heating tunnel is an additional influential parameter alongside the actual production parameters, which makes it difficult to set up automatic control loops.

U.S. Pat. No. 3,930,781A shows a post-cooling device that is attached to a calibration basket. The post-cooling device has a cooling air ring arranged on the other side of the film solidification line with air outlet openings directed towards the film tube, which consists of a number of individual blowing elements, which are connected to each other in pairs at their adjacent ends so that they can be pivoted about horizontal ax-es and are radially adjustable in relation to the tube axis and form a uniform polygon with each other.

### SUMMARY

This section provides a general summary of the disclosure and is not a comprehensive disclosure of its full scope or all of its features.

The present disclosure relates to a method and a blown film line for producing a film tube from plasticized thermoplastic material in a haul-off direction along a longitudinal axis of the blown film line by means of a blow head. By means of at least one cooling gas ring in haul-off direction downstream of the blow head, a cooling gas is blown onto the film tube so that the film tube solidifies at a frost line under the effect of the cooling gas.

The object of the present invention is to provide a blown film line which has a post-tempering unit which is as effective and variable as possible downstream of the frost line.

The object is achieved by a method for post-tempering a film tube extruded by means of a blown film line, the method including: ejecting a film tube of plasticized thermoplastic material in a haul-off direction along a longitudinal axis of the blown film line by means of a blow head; blowing cooling gas onto the film tube, relative to the haul-off direction downstream of the blow head by means of at least one cooling gas ring, so that the film tube solidifies at a frost line under the effect of the cooling gas; post-tempering the film tube by means of a post-tempering unit downstream of the frost line, the post-tempering unit having a plurality of adjustable blowing elements for blowing tempering gas onto the film tube, said blowing elements forming a feed-through opening for the film tube; adapting a diameter of the feed-through opening formed by the blowing elements to a diameter of the film tube by adjusting the blowing elements; measuring the actual temperature of the film tube downstream of at least one of the blowing elements; and regulating the temperature of the film tube downstream of the at least one blowing element to a target temperature by blowing tempering gas onto the film tube by means of the post-tempering unit.

The actual temperature of the film tube can be measured at any point downstream of at least one of the blowing elements, i.e., in an area of the film tube in which it is round, or in an area in which the film tube is no longer round, for example in a collapsing unit or downstream of it, i.e., in or downstream of a haul-off unit. This means that the actual temperature can also be measured in an area that is no longer in line with the longitudinal axis of the blown film line.

By precisely regulating the temperature of the film tube, excessive subsequent cooling or heating is avoided, so that energy efficiency can be increased.

It also ensures a high level of consistency in the process. Changes in the ambient conditions, such as the ambient temperature and/or the humidity of the ambient air, can lead to significant changes in the temperature of the film tube with the same machine parameters. In the worst case, this can lead to blockages or film defects. However, fluctuations in machine parameters, such as the output quantity of plasticized material and/or the output speed, also lead to temperature changes in the film tube. The adjustment to a target temperature of the film tube results in a higher consistency of the process and therefore a higher quality of the film tube produced.

The post-tempering unit may have a plurality of guide elements, which are adjustably articulated on the frame, for guiding the film tube and form a guide opening for guiding through the film tube, a diameter of the guide opening being adapted to a diameter of the film tube by adjusting the guide elements.

The actual temperature profile of the film tube can be measured over the circumference, at least over at least one circumferential area, of the film tube, whereby temperatures and/or volume flows of the tempering gas of the blowing elements arranged distributed over the circumference are each set as a function of the difference between the actual temperature in the respective circumferential area of the film tube of the respective blowing element and the target temperature in the respective circumferential area of the film tube.

To avoid blocking, the film tube can be cooled downstream of the frost line, at least in certain areas around the circumference. To improve the flatness quality, the film tube can be heated downstream of the frost line, at least in some areas around the circumference.

The actual temperature of the film tube can be measured in an area of an outlet of the post-tempering unit from which the film tube exits the post-tempering unit.

A temperature and/or a volume flow of the tempering gas can be set depending on the difference between the measured temperature of the film tube and the target temperature of the film tube. The target temperature can be a specific absolute temperature value. Alternatively, it is also possible for the target temperature to be calculated from a differential value based on the actual temperature of the film tube before it passes through the post-tempering unit. In this case, the target temperature is calculated from the actual temperature of the film tube before it passes through the post-tempering unit plus or minus a fixed temperature difference value, if applicable.

The temperature sensor for measuring the temperature of the tubular film can be located anywhere downstream of the post-tempering unit, for example on the collapsing unit. The temperature sensor can also be part of the post-tempering unit, in which case the temperature sensor is arranged in the area of an outlet of the post-tempering unit.

In special applications, it may be necessary to influence the temperature profile differently over the circumference, for example to set a constant temperature profile over the circumference based on local conditions, starting from a non-uniform temperature profile over the circumference. It may also be necessary to set a non-uniform temperature profile around the circumference. For this purpose, it may be provided that a temperature profile of the film tube downstream of the post-tempering unit, in particular in an area of the outlet of the post-tempering unit from which the film tube exits the post-tempering unit, is measured over the circumference and that temperatures and/or volume flows of the tempering gas of the blowing elements arranged distributed over the circumference are each set as a function of the difference between the temperature in the respective circumferential area of the film tube of the respective blowing element and the target temperature in the respective circumferential area of the film tube.

The temperature of the tempering gas can be between 5° C. and 150° C., in particular between 8° C. and 110° C. The target temperature of the film tube downstream of the post-tempering unit can be between 35° C. and 110° C., in particular between 45° C. and 80° C.

Furthermore, an annular air curtain can be blown out essentially parallel to the longitudinal axis and around the flow of the tempering gas. The air curtain thus envelops the tempering gas flow and protects it from external influences and from excessive mixing with ambient air that has a different temperature to the tempering gas.

The film tube can be guided downstream of the at least one cooling gas ring and downstream of the frost line by means of a calibration basket with a plurality of calibration elements which are configured to enclose the film tube and form a calibration opening, the calibration elements being adjusted to set a diameter of the calibration opening.

The object is further achieved by a blown film line which has a blow head for ejecting a film tube of plasticized thermoplastic material in a haul-off direction along a longitudinal axis of the blown film line, at least one cooling gas ring in the haul-off direction downstream of the blow head for blowing cooling gas onto the film tube in order to allow the film tube to solidify at a frost line under the action of the cooling gas. A post-tempering unit for post-tempering the film tube is configured and intended to be arranged downstream of the frost line. The post-tempering unit has a plurality of blowing elements for blowing tempering gas onto the film tube, said blowing elements are configured to enclose the film tube and form a feed-through opening for the film tube, and said blowing elements are adjustable for setting a diameter of the feed-through opening. A temperature sensor for detecting the temperature of the film tube is arranged downstream of at least one of the blowing elements, the blown film line having a control unit which is set up to regulate the temperature of the film tube downstream of the at least one blowing element to a target temperature by blowing tempering gas onto the film tube by means of the post-tempering unit.

The at least one cooling gas ring can form a central opening for the film tube to pass through and have at least one internal outlet nozzle for cooling gas.

The post-tempering unit can have a plurality of guide elements which are configured to enclose the film tube and form a guide opening in order to guide the film tube, the post-tempering unit has a frame to which the guide elements are adjustably articulated in order to set a diameter of the guide opening.

The diameter of the calibration opening, the guide opening and the feed-through opening is to be understood as the largest possible diameter of an imaginary circle within the adjustable elements, i.e. the calibration elements of the calibration basket as well as the guide elements and the blowing elements of the post-tempering unit.

If the post-tempering unit has both blowing elements and guide elements, it is ensured that the film tube is fed as centrally as possible to a downstream unit, such as a collapsing unit. The combination of blowing elements and guide elements in one unit also allows a high flow rate of the tempering gas to the film tube without affecting the position of the film tube too much or causing vibrations in the film tube. It also prevents the film tube from touching the blowing elements. Furthermore, the combination of blowing elements and guide elements in one unit results in a low installation height of the post-tempering unit.

The possible high flow velocities also increase the temperature control effect. Especially when cooling the film tube, efficient post-cooling is made possible by blowing in tempering gas at a high inflow velocity, so that a shorter post-cooling distance is required for convection cooling after the at least one cooling gas ring. The longer the post-cooling period, the longer the post-cooling section must be. This leads to correspondingly high blown film lines. A more effective temperature control effect during cooling means that the required post-cooling section can be shorter. The blown film line therefore has a more compact design and a lower height overall.

In addition, efficient and variable post-tempering is made possible by the fact that the blowing elements are adjustably hinged to the frame to set the diameter of the feed-through opening. This ensures that the blowing elements are always at a constant distance from the produced film tube, regardless of its diameter.

The post-tempering unit can also be designed to heat and/or cool the film tube. For this purpose, the post-tempering unit can have a cooling unit for cooling the tempering gas and/or a heating unit for heating the tempering gas. To reduce or prevent the film from sticking together (blocking) when folding, the film tube can be post-cooled. This means that the blown film line can be operated at a higher output, i.e. at a higher haul-off speed of the film tube, without running the risk of the film tube being fed to the collapsing unit when it is too hot and there is a risk of blocking. The output rate, i.e. the amount of film produced per time, can therefore be increased. Furthermore, the use of additives in the plastic material to reduce the tendency to blocking can be reduced or possibly even avoided. In addition to cost savings, the reduction of additives can also have a positive effect on the service life of the extruder's screw or extruders. Additives to reduce the tendency to block usually include mineral fillers, which can result in increased wear of the extruder components, especially the screw.

To improve the flatness of the film tube, however, the film tube can be reheated to reduce uneven stress distributions in the molecular structure. This improves the flatness and evenness of the film tube.

A particular advantage here is that one and the same post-tempering unit is equally suitable for cooling tubular films made of material that is sensitive to blocking and for heating tubular films made of material that is sensitive to flatness. This means that the post-tempering unit does not have to be replaced when switching between blocking-sensitive material and flatness-sensitive material.

To blow tempering gas onto the film tube, the blowing elements can each have at least one inward-facing blowing nozzle. The at least one blowing nozzle can be designed as a slit in the circumferential direction around the film tube. Several short slots or openings can also be arranged one behind the other or next to each other in the circumferential direction. The at least one blowing nozzle should be designed or arranged in such a way that a uniform flow of tempering gas to the film tube is possible.

In one embodiment of the blown film line, the blowing elements and/or an air distributor ring, which is arranged radially outside the blowing elements and supplies them with tempering gas, can each have at least one outlet nozzle pointing radially outside the at least one blowing nozzle, at least essentially parallel to the longitudinal axis, in order to produce an air curtain flowing out around the longitudinal axis in an annular shape parallel to the axis. It is also conceivable that a separate ring is provided to generate an air curtain. The air curtain envelops the tempering gas flow and protects it from external influences and from excessive mixing with ambient air at a different temperature.

It can be advantageous for the blowing elements to be arranged downstream of the guide elements. The tempering gas hits the film tube after exiting the at least one blowing nozzle and is drawn along in the haul-off direction of the film tube. If the blowing elements are arranged downstream of the guide elements, at least a part, preferably the largest part, of the tempering gas does not hit the guide elements and is therefore not deflected or swirled. This enables the longest possible distance over which the tempering gas can act on the film tube without being influenced.

In an exemplary embodiment, the blowing elements and the guide elements can be adjusted synchronously. This ensures that, regardless of the diameter of the film tube, the blowing elements are always at a constant distance from the film tube or that the blowing elements are set back radially from the guide elements by a constant amount.

In order to enable synchronous adjustment of the blowing elements and guide elements, the post-tempering unit can, for example, have several carriers distributed around the circumference, which are adjustably hinged to the frame. At least one of the blowing elements and at least one of the guide elements can then be attached to each of the carriers.

When the blowing elements are arranged radially set back from the guide elements, the diameter of the guide opening of the post-tempering unit, which is formed by the guide elements, is smaller than the diameter of the feed-through opening of the post-tempering unit, which is formed by the blowing elements.

According to an exemplary embodiment, the blown film line comprises a collapsing unit downstream of the post-tempering unit for folding the film tube. Here, an area between the post-tempering unit and the collapsing unit is free of elements that in-fluence the film tube.

An annular baffle plate arrangement can be arranged downstream of the post-tempering unit, through which the film tube is fed. The baffle plate arrangement can consist of individual baffle plates, each of which is connected to one of the carriers of the blowing elements or the guide elements. The individual baffle plates are arranged next to each other around the circumference and together form a ring. The baffle plate arrangement is used to hold the tempering gas on the film tube over a certain length and to protect it from external influences and to prevent excessive mixing with ambient air at a different temperature.

The post-tempering unit can also have a suction unit for at least partial extraction of the tempering gas. If the blowing elements blow out as far as possible in the haul-off direction, the suction unit can be arranged downstream of the blowing elements. If the blowing elements blow out largely against the haul-off direction, the suction unit can be arranged upstream of the blowing elements. The suction unit can be fluidically connected to a supply for tempering gas for the blowing elements. Under certain conditions, this makes it possible to reduce the amount of energy required to pre-temper the tempering gas. In particular, a control system can be provided that regulates the volume flow of the recirculated tempering gas by means of the suction unit in order to achieve the highest possible energy recovery.

In one embodiment, at least one temperature sensor for detecting the temperature of the film tube is arranged upstream of the blowing elements around the circumference of the longitudinal axis.

The blown film line can also have a temperature sensor for detecting the temperature of the tempering gas.

This allows the temperature of the film tube downstream of the blowing elements to be determined and controlled. For this purpose, the temperature sensor can be arranged on the carrier for the blowing elements or the guide elements or on the frame in the area of the outlet of the post-tempering unit or on any other element of the blown film line downstream of the post-tempering unit.

In one embodiment, the temperature of the film tube can be determined by means of the temperature sensor upstream of the blowing elements. For this purpose, the temperature sensor can be arranged on the carrier for the blowing elements or the guide elements or on the frame in the area of the inlet of the post-tempering unit or on any other element of the blown film line upstream of the post-tempering unit.

Depending on the temperature of the film tube upstream and/or downstream of the blowing elements or a temperature difference between the temperatures of the film tube upstream and downstream of the blowing elements and a difference between a target temperature and the actual temperature of the film tube downstream of the blowing elements, the temperature and/or the volume flow or the pressure of the tempering gas can be adjusted.

For this purpose, the blown film line can also include a pressure sensor and/or a volume flow sensor for detecting the pressure or volume flow of the tempering gas. The pressure can be used to infer the volume flow of the tempering gas. The sensor is preferably located within a line system for supplying the blowing elements with tempering gas. This means that the sensor can be located anywhere between a blower for generating pressure and the blowing nozzles of the blowing elements.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a general view of a blown film line with a first embodiment of a post-tempering unit;

FIG. 2 is an enlarged view of a blown film line in the area of a second embodiment of a post-tempering unit;

FIG. 3 is an enlarged view of a blown film line in the area of a third embodiment of a post-tempering unit;

FIG. 4 is an enlarged view of a blown film line in the area of a fourth embodiment of a post-tempering unit;

FIG. 5 is a top front view of the post-tempering unit according to FIG. 1;

FIG. 6 is a side view of the post-tempering unit according to FIG. 5, viewed radially outwards from the longitudinal axis; and

FIG. 7 is an enlarged top view of the post-tempering unit according to FIG. 5 in a further embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

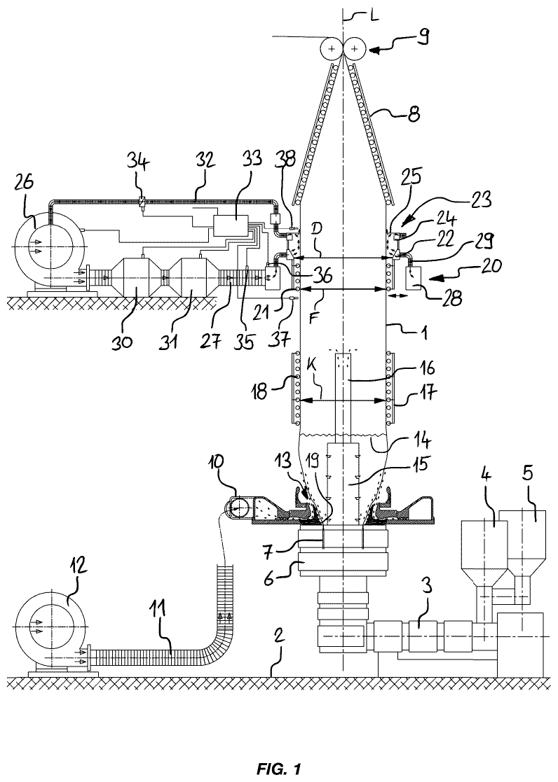

FIG. 1 is a side view partial in longitudinal section along a longitudinal axis L of a blown film line for the production of a film tube 1. An extruder 3 stands on a machine foundation 2, on which two feed hoppers 4, 5 for thermoplastic material can be seen. A thermoplastic material fed in granular form via the feed hoppers 4, 5 is plasticized and homogenized by pressure and additional heating means in a screw of the extruder 3 and pressed into a blow head 6, adjoining the extruder 3, with vertical axis along the longitudinal axis L of the blown film line. The blow head 6 has a schematically represented ring nozzle 7 on its upper side, from which the expanding axially symmetrical film tube 1 emerges, initially still made of plasticized film material. After solidification of the film material, the film tube 1 substantially retains its diameter. The film tube 1 is pressed flat in a collapsing unit 8 and pulled off upwards by a haul-off unit 9. The flattened film tube 1 is then wound onto coils (not shown here). In the direction from the blow head 6 to the haul-off unit 9, the functional terms “in front of” and “downstream” are used in such a way that they mean “below” and “above” in spatial relationship.

Immediately above the blow head 6, a cooling gas ring 10 with a partially schematically represented gas supply line 11 is shown. The gas supply line 11 is connected to a blower 12 on the inlet side, via which cooling gas, usually air, is conveyed to the cooling gas ring 10. For this purpose, ambient air is drawn in by blower 12. Other cooling gases or cooling gas mixtures can also be used. The cooling gas ring 10 has internal outlet nozzles 13, from which the cooling gas flows out and flows onto the film tube 1, which is under increased internal pressure and is guided through a central opening 19 of the cooling gas ring 10, in a ring shape essentially parallel to the wall. The cooling gas flow from the blower 12 to the film tube 1 is symbolized by arrows. The film tube 1 plasticized in this area initially expands in diameter under the aforementioned excess pressure inside until it solidifies under the action of the cooling gas and assumes a constant diameter. The point of transition from the plasticized material to the hardened material is called the “frost line” and is designated 14. The frost line 14 does not have to be a clear line, but can extend over a limited area in the direction of the longitudinal axis L. To generate an internal overpressure, an internal cooling tower 15 is mounted centrally on the blow head 6, via which cooling gas is introduced into the interior of the film tube 1. The cooling gas introduced is discharged via a gas extraction pipe 16 in such a way that a defined internal pressure prevails.

Above, i.e. downstream of the frost line 14 in the haul-off direction along the longitudinal axis L, there is a calibration basket 17, which contains calibration elements 18 with superimposed roller arrangements, which are essentially arranged in a ring around the film tube 1. In order to enable adaptation to film tubes 1 of different diameters, the roller arrangements are generally located on pivoting segments forming individual partial circumferences, by means of which the diameter of a calibration opening of the calibration basket 17, through which the film tube 1 is guided along the longitudinal axis L, can be changed. In cross-section, these segments form a polygon-shaped calibration opening. In the example shown, the calibration opening has a diameter K.

The cross-section of the still relatively warm film tube 1 is stabilized and guided by the calibration basket 17. The calibration basket 17 may be arranged in a height-adjustable manner relative to the blow head 6, in order to always be able to assume an optimum height position relative to the frost line 14.

A post-tempering unit 20 is arranged downstream of the calibration basket 17 and is used to post-temper the film tube 1. The post-tempering unit 20 has several guide elements 21 with roller arrangements, although other guide elements can also be provided instead of the roller arrangements. The guide elements 21 enclose the film tube 1 and form a guide opening with a diameter F. In this design example, the diameter F of the guide opening is identical to the diameter K of the calibration opening. The guide elements 21 are used, among other things, to guide the film tube 1 centrally to the longitudinal axis L, so that the film tube 1 is guided centrally into the collapsing unit 8 in order to avoid creases or edge misalignment. As will be explained in detail below, the guide elements 21 are adjustably hinged to a frame of the post-tempering unit 20 in order to be able to vary the diameter F of the guide opening.

In addition, the post-tempering unit 20 has several blowing elements 22, which enclose the film tube 1 and form a feed-through opening for the film tube 1 with a diameter D. As explained in more detail below, the blowing elements 22 are also adjustably hinged to the frame of the post-tempering unit 20 to set the diameter D of the feed-through opening. The blowing elements 22 blow the tempering gas diagonally upwards in the haul-off direction onto the film tube 1. In principle, however, it is also conceivable that the tempering gas is blown out horizontally, i.e. in a plane perpendicular to the longitudinal axis L, against the film tube 1.

The diameters K, F and D are each defined as the largest possible diameter of an imaginary circle within the adjustable elements, i.e. the calibration elements 18 of the calibration basket 17 as well as the guide elements 21 and the blowing elements 22 of the post-tempering unit 20.

A suction unit 23 is arranged downstream of the blowing elements 22, through which the film tube 1 is guided centrally. The suction unit 23 comprises one or more suction elements 24 for extracting tempering gas. In order to extract as much tempering gas as possible before it enters the environment, a baffle plate arrangement with several baffle plates 25 is provided downstream of the at least one suction element 24, which is designed in a circular shape and arranged transversely to the longitudinal axis L and has a relatively small distance to the film tube 1 compared to the distance of the at least one suction element 24. The individual baffle plates 25 are each attached to one of the blowing elements 22, but can also be arranged on a carrier 47 to which the blowing elements 22 are attached. The suction element 24 can be designed as a rigid circumferential ring. Alternatively, it is also possible that several suction elements 24 are arranged around the circumference, whereby these are arranged in a pivotable manner similar to the blowing elements 22 in order to vary the inner diameter of the suction unit 23 and to be able to adapt it to different film tube diameters.

The blowing elements 22 are supplied with tempering gas by a blower 26. The blower 26 draws in ambient air and directs it to the blowing elements 22. A feed line 27, which connects the blower 26 to an air distributor ring 28 of the post-tempering unit 20, is used for this purpose. The air distribution ring 28 is arranged in a ring around the film tube 1 and, in the example shown, around the guide elements 21 and is used to distribute the tempering gas evenly around the circumference. The air distribution ring 28 is fluidically connected to the individual blowing elements 22 via supply lines 29.

A cooling unit in the form of an air cooler 30 and a heating unit in the form of an air heater 31 are arranged in the feed line 27, whereby external cooling or heating sources can also be used. This means that the tempering gas can be cooled or heated as required before it is fed to the blowing element 22. Alternatively, it is also possible that only an air cooler 30 or only an air heater 31 is provided. The order in which the blower 26, the air cooler 30 and the air heater 31 are arranged can be selected as required.

It should be noted that the blower 26, the air cooler 30 and the air heater 31 are shown at the level of the post-tempering unit 20. For this purpose, these components can be arranged in a tower frame of the blown film line. However, they can also stand on the machine foundation.

The at least one suction element 24 is fluidically connected to the blower 26 via an exhaust line 32. This means that the tempering gas can be fed upstream of the air cooler 30 and the air heater 31 via the blower 26 for energy recovery in order to re-duce the required heating or cooling capacity.

The blown film line also has a control unit 33, which is connected to the blower 26, the air cooler 30 and the air heater 31 in order to control them. In addition, the control unit 33 is connected to a control flap 34 in the exhaust line 32 in order to control the volume flow of the recirculated tempering gas in the exhaust line 32. The signals from several sensors are processed for the control system. The control unit 33 is equipped with a temperature sensor 35 in the feed line 27 for detecting the temperature of the tempering gas, with a pressure sensor 36 on the air distribution ring 28 for detecting the pressure in the air distribution ring 28, to a temperature sensor 37 upstream of the post-tempering unit 20 for detecting the temperature of the film tube 1 before it enters the post-tempering unit 20 and to a temperature sensor 38 downstream of the post-tempering unit 20 for detecting the temperature of the film tube 1 after it exits the post-tempering unit 20.

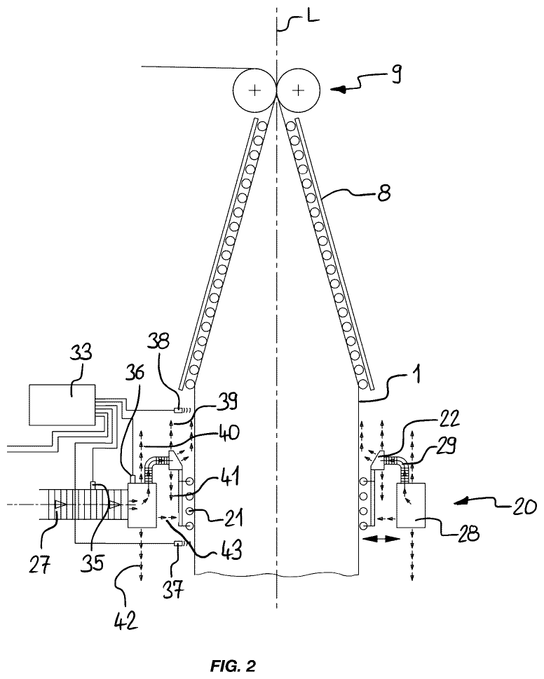

FIG. 2 shows an enlarged view of a blown film line in the area of a second embodiment of a post-tempering unit 20. Components that correspond to components of the blown film line shown in FIG. 1 are marked with the same reference signs and described there.

In contrast to the post-tempering unit 20 according to the first embodiment, the post-tempering unit 20 of the second embodiment has no suction unit and no baffle plate arrangement. One or more air curtains can be blown out to ensure that the tempering gas flowing out of the blowing elements 22 is as laminar as possible along the surface of the film tube 1. For example, an inner air curtain 39 flowing in the haul-off direction can be blown out, which flows out through openings not shown in detail in the blowing elements 22 and thus encloses the tempering gas between itself and the film tube 1. Alternatively or additionally, an external air curtain 40 flowing in the haul-off direction can be blown out, which flows out through openings of the air distributor ring 28 not shown in detail.

Again, alternatively or additionally, an inner air curtain 41 flowing against the haul-off direction can be provided, which is blown out of openings of the blowing elements 22 not shown in detail. Furthermore, alternatively or additionally, an external air curtain 42 flowing against the haul-off direction can be provided, which is blown out of openings of the air distributor ring 28 not shown in detail.

In addition or alternatively, a radially flowing lower air curtain 43 can be blown out of openings of the air distributor ring 28 not shown in detail.

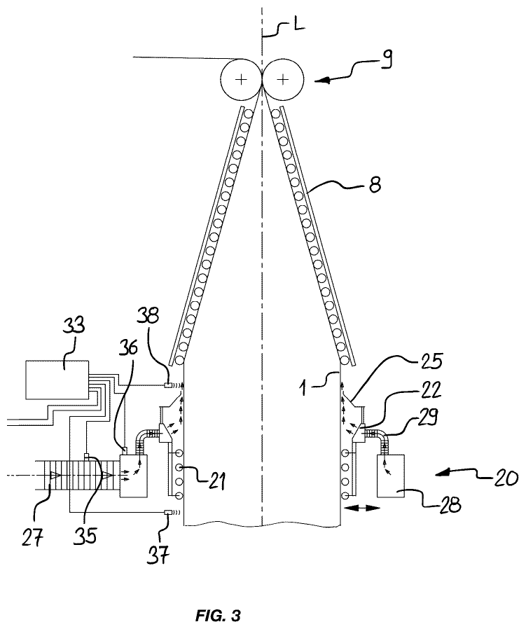

FIG. 3 shows an enlarged view of a blown film line in the area of a third embodiment of a post-tempering unit 20. Components which correspond to components of the blown film line according to FIGS. 1 and 2 are provided with the same reference signs and are described there.

In contrast to the post-tempering unit 20 according to the second embodiment, no air curtains are provided. Instead, the post-tempering unit 20 has a baffle plate arrangement consisting of several baffle plates 25, which are arranged downstream of the blowing elements 22. The individual baffle plates 25 are each attached to one of the blowing elements 22, but can also be arranged on a carrier 47 to which the blowing elements 22 are attached. In the example shown, the baffle plates 25 form a frustoconical baffle plate arrangement and a narrow annular slot between the in-dividual baffle plates 25 and the film tube 1 for passing the tempering gas through.

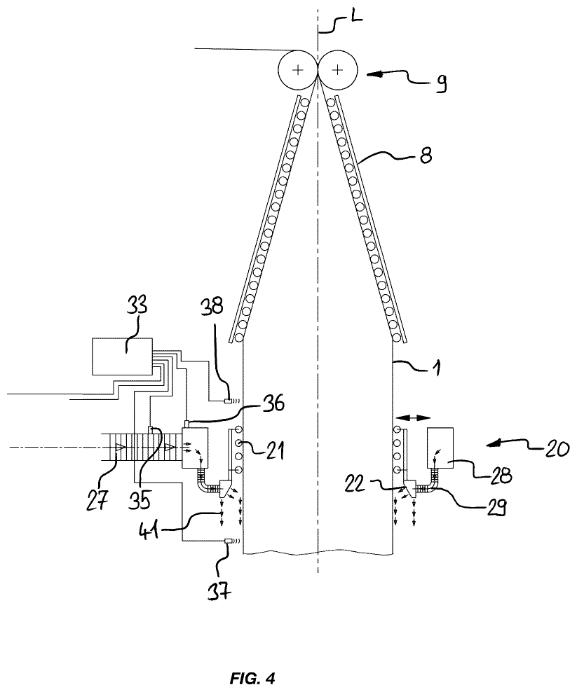

FIG. 4 shows an enlarged view of a blown film line in the area of a fourth embodiment of a post-tempering unit 20. Components which correspond to components of the blown film line according to FIGS. 1 to 3 are provided with the same reference signs and are described there.

In contrast to the post-tempering unit 20 according to the first three embodiments, in the fourth embodiment the blowing elements 22 are arranged upstream of the guide elements 21. In addition, the blowing elements 22 do not blow diagonally upwards in the haul-off direction, but diagonally downwards against the haul-off direction.

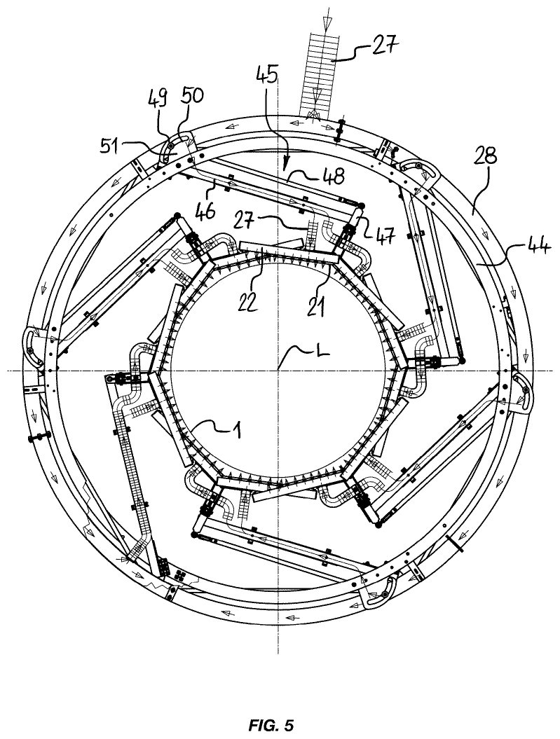

FIG. 5 shows a top view of the post-tempering unit 20 according to FIG. 1, wherein components that correspond to components of the blown film line according to FIG. 1 are provided with the same reference signs and are described there.

The post-tempering unit 20 has a frame 44 to which the movable elements de-scribed below are attached and which, if necessary, is arranged to be adjustable in height relative to the blow head. Furthermore, the air distributor ring 28 is attached to the frame 44.

The frame 44 forms a central passage through which the film tube 1 is guided parallel to the longitudinal axis L as shown in FIG. 1. There are six adjusting units 45 distributed around the circumference. The adjusting units 45 are used to adjust guide elements 21 in a direction radial to the longitudinal axis L.

The adjusting units 45 each include a pivot arm 46 pivotally attached to the frame 44. In this case, the pivot arm 46 is pivotable about a pivot axis which is arranged parallel to the longitudinal axis L.

Furthermore, the adjusting units 45 each have a carrier 47 which, in the shown embodiment, carries two guide elements 21 in the form of rollers which are spaced apart from each other in the direction of the longitudinal axis L and are arranged to overlap in a V-shape viewed in the direction of the longitudinal axis L. The carrier 47 is pivotally connected to the pivot arm 46. In this case, the carrier 47 is pivotally connected to the pivot arm 46 about a pivot axis which is arranged parallel to the longitudinal axis L.

Further, the adjusting units 45 each include a coupling rod 48 pivotally connected to the carrier 47.

Finally, the adjusting units 45 each comprise an actuating mechanism by means of which the coupling rod 48 is pivotally connected to the frame 44.

To represent the actuating mechanism, the coupling rods 48 of the adjusting units 45 are each connected to the frame 44 in a pivoting and displaceable manner via a coupling element (not shown). The coupling element is rotatably connected to the frame 44. The coupling rod 48 is slidably coupled to the coupling element. In addition, a cam follower 49 is attached to each of the coupling rods 48 and is guided along a guide 50 on the frame 44 for translational movement. In the embodiment shown, the guide 50 is a groove in a plate 51 that is fixedly attached to the frame 44. However, other guidance systems are also conceivable. The guide 50 is curvilinear in shape and adapted such that the carrier 47 is always aligned centrally with respect to the longitudinal axis L, irrespective of the distance from the longitudinal axis L or the film tube 1. This ensures precise centric alignment of the guide elements 21 in the form of the two rollers relative to the film tube 1, so that both rollers are always held in contact with the film tube 1.

In principle, other actuating mechanisms, such as parallelogram arrangements, are also conceivable, whereby it should be ensured that the carriers 47 can be adjusted at least as far as possible radially to the longitudinal axis L.

The blowing elements 22 are also attached to the carrier 47, whereby these are set back slightly radially in relation to the guide elements 21. In the embodiment example shown, the blowing elements 22 are each arranged in axial overlap with one of the guide elements 21.

In the illustration shown in FIG. 5, the guide elements 21 are not yet fully guided up to the film tube 1 in order to guide it. For the sake of clarity, the guide elements 21 are shown at a slight distance from the film tube 1.

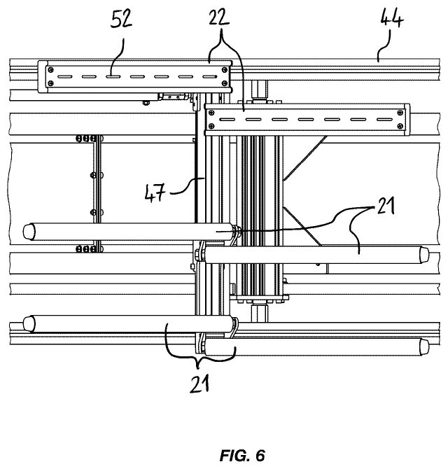

FIG. 6 shows a side view of the post-tempering unit according to FIG. 5, viewed radially outwards from the longitudinal axis. Four guide elements 21 and two blowing elements 22 are firmly mounted on the carrier 47. The guide elements 21 in the form of rollers are arranged in pairs, overlapping one above the other in a V-shape. The two pairs of guide elements 21 are arranged one above the other in a matching arrangement.

The two blowing elements 22 are arranged above the guide elements 21, i.e. downstream of the guide elements 21. Similar to the guide elements 21, the blowing elements 22 are also arranged in a V-shape, overlapping one above the other. The blowing elements 22 have blowing openings 52 on the inside, i.e. in the direction towards the film tube. The tempering gas escapes through the blowing openings 52 and flows against the surface of the film tube. In the embodiment example shown, the blowing openings 52 are arranged in such a way that the tempering gas, in contrast to the embodiments according to FIGS. 1 to 4, is not blown out at an angle to the longitudinal axis in or against the haul-off direction, but horizontally, i.e. in a plane perpendicular to the longitudinal axis L, onto the film tube.

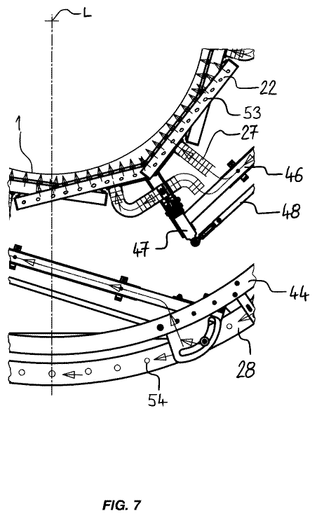

FIG. 7 shows an enlarged top view of the post-tempering unit according to FIG. 5 in a further embodiment. The embodiment of the post-tempering unit shown is largely identical to that shown in FIG. 5, with corresponding components being provided with the same reference signs. In contrast to the embodiment shown in FIG. 5, the blowing elements 22 have outlet nozzles 53 that are aligned parallel to the longitudinal axis L. The outlet nozzles 53 blow tempering gas upwards parallel to the longitudinal axis L and thus form an air curtain running around the longitudinal axis L. However, they can also be arranged additionally or alternatively on a bottom side of the blowing elements 22 and blow out an air curtain downwards.

Furthermore, in the embodiment shown, outlet nozzles 54 are also provided on the air distributor ring 28, which are aligned parallel to the longitudinal axis L. The outlet nozzles 54 blow tempering gas upwards parallel to the longitudinal axis L and thus form a further air curtain running around the longitudinal axis L. They can also be arranged additionally or alternatively on a bottom side of the air distributor ring 28 and blow out an air curtain downwards.

It is also conceivable that outlet nozzles 53, 54 are only arranged on the blowing elements 22 or only on the air distributor ring 28. Furthermore, it is also possible that a separate distributor ring is provided additionally or alternatively, which is de-signed with outlet nozzles to generate one or more air curtains. Radially aligned outlet nozzles can also be provided. In addition, a separate gas supply from the tempering gas could be provided for the formation of one or more air curtains.

The inlet nozzles 52 and the outlet nozzles 53, 54 can have any shape, for example in the form of holes or slots. For example, the blowing elements 22 can each have a single blowing nozzle 52 and/or a single outlet nozzle 53 in each direction, which extends at least approximately over the entire length of the blowing element 22. Several slot-shaped inlet nozzles 52 or outlet nozzles 53 can also be provided, which are arranged overlapping and/or at an angle to a plane perpendicular to the longitudinal axis L.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for post-tempering a film tube extruded by means of a blown film line, comprising:
ejecting the film tube of plasticized thermoplastic material in a haul-off direction along a longitudinal axis of the blown film line by means of a blow head;
blowing a cooling gas onto the film tube, relative to the haul-off direction downstream of the blow head by means of at least one cooling gas ring, so that the film tube solidifies at a frost line under an effect of the cooling gas;
post-tempering the film tube by means of a post-tempering unit downstream of the frost line, the post-tempering unit having a plurality of adjustable blowing elements for blowing a tempering gas onto the film tube, said blowing elements form a feed-through opening for the film tube;
adapting a diameter of the feed-through opening formed by the blowing elements to a diameter of the film tube by adjusting the blowing elements;
measuring an actual temperature of the film tube downstream of at least one of the blowing elements; and
regulating the temperature of the film tube downstream of the at least one blowing element to a target temperature by blowing the tempering gas onto the film tube by means of the post-tempering unit.

2. The method according to claim 1, wherein the post-tempering unit has a plurality of guide elements, which are adjustably articulated on a frame, for guiding the film tube and form a guide opening for guiding the film tube through, a diameter of the guide opening being adapted to the diameter of the film tube by adjusting the guide elements.

3. The method according to claim 1, wherein the actual temperature of the film tube is measured over at least one circumferential region of the film tube, and
wherein temperatures and/or volume flows of the tempering gas of at least one blowing element arranged in the at least one circumferential region are set in each case as a function of a difference between the actual temperature in the respective circumferential region of the film tube of the respective blowing element and the target temperature in the respective circumferential region of the film tube.

4. The method according to claim 1, wherein the film tube is cooled or heated downstream of the frost line at least in certain areas around a circumference by means of the tempering gas.

5. The method according to claim 1, wherein the actual temperature of the film tube is measured in a region of an outlet of the post-tempering unit from which the film tube emerges from the post-tempering unit.

6. The method according to claim 1, wherein a temperature and/or a volume flow of the tempering gas is set as a function of a difference between the measured actual temperature of the film tube and the target temperature of the film tube.

7. The method according to claim 1, wherein the film tube is guided downstream of the at least one cooling gas ring and upstream of the frost line by means of a calibration basket with a plurality of calibration elements which are configured to enclose the film tube and form a calibration opening, the calibration elements being adjusted to set a diameter of the calibration opening.

8. A blown film line comprising:
a blow head for ejecting a film tube of plasticized thermoplastic material in a haul-off direction along a longitudinal axis of the blown film line;
at least one cooling gas ring in a haul-off direction downstream of the blow head for blowing a cooling gas onto the film tube in order to allow the film tube to solidify at a frost line under an action of the cooling gas; and
a post-tempering unit for post-tempering the film tube, said post-tempering unit is configured and intended to be arranged downstream of the frost line,
wherein the post-tempering unit has a plurality of blowing elements for blowing a tempering gas onto the film tube, said blowing elements are configured to enclose the film tube and form a feed-through opening for the film tube, and said blowing elements are adjustable for setting a diameter of the feed-through opening,
wherein a temperature sensor for detecting a temperature of the film tube is arranged downstream of at least one of the blowing elements, and
wherein the blown film line has a control unit which is configured to regulate the temperature of the film tube downstream of the at least one blowing element to a target temperature by blowing the tempering gas onto the film tube by means of the post-tempering unit.

9. The blown film line according to claim 8, wherein the post-tempering unit has a plurality of guide elements which are configured to enclose the film tube and form a guide opening in order to guide the film tube, the post-tempering unit having a frame to which the guide elements are adjustably articulated in order to set a diameter of the guide opening.

10. The blown film line according to claim 9, wherein the blowing elements are arranged downstream of the guide elements.

11. The blown film line according to claim 9, wherein the blowing elements and the guide elements can be adjusted synchronously.

12. The blown film line according to claim 9, wherein the diameter of the guide opening of the post-tempering unit is smaller than the diameter of the feed-through opening of the post-tempering unit.

13. The blown film line according to claim 8, wherein the post-tempering unit includes a cooling unit for cooling the tempering gas and/or a heating unit for heating the tempering gas.

14. The blown film line according to claim 8, wherein the blowing elements each have at least one inward-facing blowing nozzle for blowing the tempering gas onto the film tube.

15. The blown film line according to claim 9, wherein the post-tempering unit has a plurality of carriers which are arranged distributed over a circumference and are adjustably articulated on the frame, and
wherein at least one of the blowing elements and at least one of the guide elements is fastened to each of the carriers.

16. The blown film line according to claim 8, wherein the blown film line comprises a collapsing unit downstream of the post-tempering unit for collapsing the film tube, and
wherein an area between the post-tempering unit and the collapsing unit is free of elements influencing the film tube.

17. The blown film line according to claim 8, wherein at least one temperature sensor for detecting the temperature of the film tube is arranged upstream of the blowing elements over a circumference around the longitudinal axis.

18. The blown film line according to claim 8, wherein the blown film line comprises a temperature sensor for detecting the temperature of the tempering gas.

19. The blown film line according to claim 8, wherein the blown film line comprises a pressure sensor for detecting the pressure and/or a volume flow sensor for detecting the volume flow of the tempering gas for supplying the blowing elements with the tempering gas.

20. The blown film line according to claim 8, wherein a calibration basket is arranged downstream of the at least one cooling gas ring, having a plurality of calibration elements which are configured to enclose the film tube and form a calibration opening in order to guide the film tube, the calibration elements being adjustable for setting a diameter of the calibration opening.
